(19) United States
(12) Patent Application Publication
(10) Pub. No.: US 2014/0070444 A1
(43) Pub. Date: Mar. 13, 2014

(54) Distillation preform slurry non ionic and electrolyte liquid and gaseous mechanically refined and nanoparticle dispersion under vacuum processing for Building Materials fine concrete and High Wear-Heat Resistant Parts Brushes; Windings; Coils; Battery Cells; Brake Pads; Washers; Spacers; Bushings; 1.0 to 2.5 Phase Extrusions Die Cast Molding; Refrigeration; Polarized Glass; Spectrometric Processor; Central Processing Unit Processors; Electronic Storage Media; and Precision Silica Alumina Glass Beads for Commercial Aircraft Position Lights

(71) Applicant: Robert Richard Matthews, Washington, DC (US)

(72) Inventor: Robert Richard Matthews, Washington, DC (US)

(21) Appl. No.: 13/656,682

(22) Filed: Oct. 20, 2012

Related U.S. Application Data
(63) Continuation-in-part of application No. 13/612,667, filed on Sep. 12, 2012.

(51) Int. Cl. B29C 47/88; G01J 3/46; B29C 47/00

(52) U.S. Cl. CPC B29C 47/8815; B29C 47/0004; G01J 3/46
USPC 264/105; 425/404; 702/189

(57) ABSTRACT

The variable hydraulic press and distillation reservoir manufacture process scientific formula non ionic or electrolyte mechanically refined and nanoparticle, carbon nanofoam CNFs dispersion preform slurry extrusion, with or without ionic suspension element for manufactured 1. preform slurry high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, electronic resistors, transformers, transducers, rectifiers, power supplies, or heat sinks 2. preform slurry high wear-heat resistant parts aerospace, automotive, and transportation brake calipers, rotors, pads, and bushings 3. preform slurry non ionic or electrolyte mechanically refined and nanoparticle high wear-heat resistant parts precision casting molds 2.5 phase die cast molding and 4. Building Materials fine concrete, mortar, brick, and tiles.

### DOMESTIC PRIORITY DATA

This is an application a continuation in part of preliminary amendment to specification application Ser. No. 13/612,667 Filing Date Sep. 12, 2012.

### BACKGROUND OF THE INVENTION

Global warming and growing concerns of Greenhouse gas emissions from our dependency on fossil fuels are creating real demand and awareness for an electric alternative to fossil fuel engines and expensive replacement parts. Few technological developments of collecting and manufacturing carbon nanofoam CNFs improve upon our existing technological structure. By applying scientific utilization of preform technology variable hydraulic preform slurry non ionic or electrolyte mechanically refined and nanoparticle dispersion high wear-heat resistant parts press with manufactured or processed carbon nanofoam CNFs assembled resources we can now create the manufacture process of preform slurry non ionic or electrolyte mechanically refined and nanoparticle high wear-heat resistant parts.

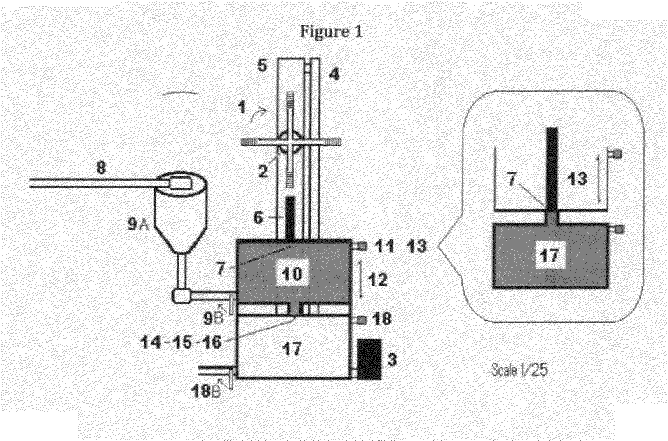

### BRIEF DESCRIPTION OF FIG. 1

FIG. 1 variable hydraulic preform slurry non ionic or electrolyte mechanically refined and nanoparticle dispersion high wear-heat resistant parts press.

### DETAILED DESCRIPTION OF FIG. 1

Variable hydraulic preform slurry non ionic or electrolyte mechanically refined and nanoparticle dispersion high wear-heat resistant parts press 1-Hydraulic control wheel 2-Electronic servo 3-Hydraulic pump 4-Hydraulic pipe 5-Hydraulic actuator 6-Hydraulic tool steel arm 7-Slurry non ionic and electrolyte tool steel press plate 8-Slurry non ionic and electrolyte tool steel line in 9A-Gravity feed tool steel collector 9B-Tool steel release portal control 10-Slurry non ionic and electrolyte tool steel reservoir 11-Slurry non ionic and electrolyte reservoir regulated tool steel waste filter 12-Slurry non ionic and electrolyte tool steel reservoir expanded 13-Slurry non ionic and electrolyte tool steel reservoir contracted 14-Slurry non ionic and electrolyte reservoir brass-tool steel aperture 15-Tool steel extrusion die cast design brass-tool steel fitting 16-Tool steel electronic servo or manual stop control release pull pin 17-Tool steel extrusion die cast design internal cavity 18-Tool steel extrusion die cast design internal cavity regulator waste filter and 18B-Tool steel vacuum release portal control.

### BRIEF SUMMARY OF THE INVENTION

Scientific utilization of preform technology variable hydraulic preform slurry non ionic or electrolyte mechanically refined and nanoparticle dispersion high wear-heat resistant parts press FIG. 1 with manufactured or processed carbon nanofoam CNFs available resources enables the manufacture process of high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, pads, washers, spacers, bushings, polarized glass, precision silica alumina glass and thermoplastic polymer beads, and precision casting molds for the manufacturing of highly pure metal, super alloy, highly pure carbon, ceramics, silica alumina, acid solids, alkalines, glass, acrylic, thermoplastic polymers, halide, alkalide, antimonide, nonconductive zirconia, carbon nanofoam CNFs, alternate carbon nanofoam inductor ACNFI, and impedance matching load or signal ceramic red brick clay insulators 1.0 to 2.5 phase extrusions for each A and B specification part.

### DETAILED DESCRIPTION OF THE INVENTION

The variable hydraulic preform slurry non ionic or electrolyte mechanically refined and nanoparticle dispersion allotropes of carbon atomic number 6 symbol C herein referred to as preform slurry non ionic or electrolyte mechanically refined and nanoparticle high wear-heat resistant parts press the center of this utility patent application specification manufacture process of specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys manufactured 1. preform slurry non ionic or electrolyte mechanically refined and nanoparticle high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 2. preform slurry non ionic or electrolyte mechanically refined and nanoparticle high wear-heat resistant parts aerospace, automotive, and transportation brake calipers, rotors, pads, washers, spacers, and bushings 3. preform slurry non ionic or electrolyte mechanically refined and nanoparticle high wear-heat resistant parts precision casting molds for the manufacturing of highly pure metal, super alloy, highly pure carbon, ceramics, silica alumina, acid solids, alkalines, glass, acrylic, thermoplastic polymers, halide, alkalide, antimonide, nonconductive zirconia, carbon nanofoam CNFs, alternate carbon nanofoam inductor ACNFI, and impedance matching load or signal ceramic red brick clay insulators 1.0 to 2.5 phase extrusions for each A and B specification part and 4. Building Materials preform slurry non ionic or electrolyte mechanically refined and nanoparticle dispersion fine concrete, mortar, brick, and tiles.

Distillation Reservoir and Recovery Basin super alloy and/or ceramics and/or highly pure carbon and carbon nanofoam CNFs fillers and adhesive insulators and Variable hydraulic press plate 1.0 to 2.0 phase extrusions 1.0 polarized extrusion with positively and negatively molten charging distillation glass optical, lenses, and mirrors with or without silica sands, mineral sands, alumina, Nano alumina, highly pure carbon, alkalines, carbon nanofoam CNFs, alternate carbon nanofoam inductor ACNFI, gold, or platinum and 2.0 extrusion acrylic and thermoplastic polymers. Other distillation processing mechanically refined and nanoparticle preform slurry non ionic or electrolyte dispersion or molten highly pure metal, super alloy, highly pure carbon, carbon nanofoam CNFs, alternate carbon nanofoam inductor ACNFI, Nano alumina, alumina, silica alumina, silica mineral, mineral sands, heavy minerals, glass, acrylic, thermoplastic polymer, acid solid, impedance matching ceramic red brick insulator, molybdenum, ceramic zirconia, ceramic silica, ceramic clay, calcium carbonate, alkaline, minerals, including ionic suspension elements and ceramic silica mineral insulator for Specification 50 elements highly pure metal, and Specification 51 alloys. Distillation reservoir halogen, highly pure ammonia, and antimony battery and other gaseous suspension elements mechanically refined and nanoparticle carbon nanofoam CNFs, alternate carbon nanofoam inductor ACNFI, alumina, Nano alumina, nickel, cadmium, lithium, magnesium, lead, antimonide, halide, alkaline, acid solid, and alkalide distillation processing and/or for up to four molten pours 1.0 to 1.0 to 2.5 phase extrusions or preform slurry non ionic or electrolyte. Both processes molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 50 elements argon, carbon monoxide, carbon dioxide, or other gases mechanically refined or nanoparticle suspension catalyst greater or lesser than ordinary atmospheric pressure. Super alloy super cooling refrigeration vacuum pump and super alloy venturi curved or linear expression comprising a scientific aperture, a divergence measured in angulation, and a scientific aperture diffusion gaseous particle accelerator super cooling refrigeration deceleration with or without nanoparticle synthesizing laser ablation and multi-waveform ablation X, Y, And Z alignment and fractional vacuum distillation gaseous and/or positive and negative ionic charges recovery and super alloy and/or ceramics and/or highly pure carbon and carbon nanofoam CNFs fillers and adhesive insulators distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6 C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6 C allotropes of carbon and liquid and/or liquid vapors and/or gaseous electrolyte catalyst acids and solid materials highly pure metal, super alloy, highly pure carbon, carbon nanofoam CNFs, alternate carbon nanofoam inductor ACNFI, Nano alumina, alumina, silica alumina, silica mineral, mineral sands, heavy minerals, glass, acrylic, thermoplastic polymer, acid solid, impedance matching ceramic red brick insulator, molybdenum, ceramic zirconia, ceramic silica, ceramic clay, calcium carbonate, alkaline, minerals, including ionic suspension elements and ceramic silica mineral insulator for Specification 50 elements highly pure metal, and Specification 51 alloys for building materials trade name preform modular alkalines, clays, and sands for fine concrete, mortar, bricks, tiles, and high wear-heat resistant parts brushes, windings, coils, battery cells, electronic resistors, capacitors, brake pads, washers, spacers, bushings, annealing, drawn, spun, coils, windings, wire, woven textile mesh, shielding, and 1.0 to 2.5 phase extrusions die cast molding.

Building materials fine concrete and mortar is mixed in distillation reservoir under vacuum control with nitrogen liquid vapors and gaseous electrolyte mechanically refined mineral sands and heavy minerals dispersion. Preform modular fine concrete arrives in trucks readymade utilized with manufacture process connector system comprised of super alloy forge tool steel die cast tool, crimping tool with manufacture process connector system rebar cable, rebar mesh, and connectors that work with easy to build box framing techniques and preform modular fine readymade concrete poured directly from hydraulic pump on readymade truck. Ready mix mortar is packaged and distributed in specially made thermoplastic sealed injection molded preformed containers and airtight dispenser system.

Supplemental super alloy super cooling refrigeration vacuum pump and super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas super cooling super alloy or super alloy venturi.

Self contained carbon dioxide CO2 refrigeration unit commercial, residential, or portable super alloy vacuum pump drawing carbon dioxide CO2 gas through insulated super alloy feeder tubes in a parallel circuit to separate super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas is then passed over super alloy and through cooling fan.

Self contained carbon dioxide CO2 refrigeration unit commercial, residential, or portable super alloy vacuum pump rated alternating current AC or direct current DC drawing carbon dioxide CO2 gas through insulated super alloy feeder tubes in a parallel circuit to separate numeric super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding the inner cylinders forcing the carbon dioxide CO2 filled outer cylinders through a continuous circuit of super alloy venturi curved or linear expression comprising a scientific aperture, a divergence measured in angulation, and a scientific aperture diffusion carbon dioxide CO2 gaseous particle accelerator super cooling refrigeration deceleration temperature to greater than −109 degrees Fahrenheit or −78.5 degrees Celsius carbon dioxide CO2 forming dry ice in the outer internal cylinders.

Distillation and recovery basin automation mass production variable hydraulic press plate mold and Super alloy, and/or ceramic, and carbon nanofoam CNFs, and alternate carbon nanofoam inductor ACNFI fillers and adhesive insulators pour aperture located in the center and hydraulic cylinder located on the right expanded and contracted for molten pouring highly pure metal printed circuits, super alloy including carbon nanofoam CNFs printed circuits nickel, cadmium, lithium, lead, antimonide, halide, alkalide, Specification 50 elements printed circuits, or Specification 51 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production crucible casted molten highly pure metal printed circuits, super alloy, carbon nanofoam CNFs printed circuits nickel, cadmium, lithium, lead, antimonide, halide, alkalide, Specification 50 elements printed circuits, or Specification 51 alloys printed circuits and/or ceramic insulator for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production variable hydraulic press plate mold and Super alloy, and/or ceramic, and carbon nanofoam CNFs, and alternate carbon nanofoam inductor ACNFI fillers and adhesive insulators pour aperture located in the center and hydraulic cylinder located on the right expanded and contracted for pouring non ionic or electrolyte preform slurry with mechanically refined and nanoparticle dispersion fine printing highly pure metal printed circuits, super alloy including carbon nanofoam CNFs printed circuits, carbon nanofoam CNFs printed circuits, alternate carbon nanofoam inductor ACNFI printed circuits, carbon nanofoam CNFs ionic suspension element printed circuits nickel, cadmium, lithium, magnesium, lead, antimonide, Specification 50 elements printed circuits, or Specification 51 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production crucible casted non ionic or electrolyte preform slurry with mechanically refined or nanoparticle dispersion fine printing highly pure metal printed circuits, super alloy including carbon nanofoam CNFs printed circuits, carbon nanofoam CNFs printed circuits, alternate carbon nanofoam inductor ACNFI printed circuits, carbon nanofoam CNFs ionic suspension element printed circuits nickel, cadmium, lithium, magnesium, lead, antimonide, Specification 50 elements printed circuits, or Specification 51 Alloys printed circuits and/or ceramic for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation reservoir interchangeable combinations of preform slurry non ionic, electrolyte, or molten ceramic and conductive circuits 2.0 extrusions or castings are accomplished for each specification part.

Alternate carbon nanofoam inductor ACNFI electronic storage media is manufactured plates, sheets, foil, or leaf on ceramic, highly pure metal, super alloy, or distillation reservoir alternate carbon nanofoam inductor ACNFI annealing, drawing, and spun pressed electronic tape 3250 bits per second BPS, 6250 bits per second BPS, 7 MM millimeter, and compact disc CD writable random access memory WRAM.

Manufacture process of 1.0 to 2.5 phase extrusions die cast molding for precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators. The precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators is a layered greater than 0% to less than 100% precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators and greater than 0% to less than 100% other precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part that is created by pouring molten metal, alloy, halide, alkalide, antimonide, ceramic, glass, acid solid, alkaline, thermoplastic polymer, non molten formula ceramic slip, acid solid, alkaline, and preform slurry non ionic or electrolyte carbon nanofoam CNFs, or alternate carbon nanofoam inductor ACNFI fillers and adhesive insulators into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, thermoplastic polymer, including preform slurry non ionic or electrolyte carbon nanofoam CNFs, or alternate carbon nanofoam inductor ACNFI fillers and adhesive insulators and Part Z the internal layer other highly pure metal, super alloy, halide, alkalide, antimonide, ceramic, glass, thermoplastic polymer, acid solid, alkaline, including preform slurry non ionic or electrolyte carbon nanofoam CNFs, or alternate carbon nanofoam inductor ACNFI fillers and adhesive insulators. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including carbon nanofoam CNFs, or alternate carbon nanofoam inductor ACNFI fillers and adhesive insulators and greater than 0% to less than 100% other highly pure metal, super alloy, super material including carbon nanofoam CNFs, and alternate carbon nanofoam inductor ACNFI fillers and adhesive insulators. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte carbon nanofoam CNFs, or alternate carbon nanofoam inductor ACNFI fillers and adhesive insulators sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace. The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including carbon nanofoam CNFs, or alternate carbon nanofoam inductor ACNFI fillers and adhesive insulators fills. After the poured molten highly pure metal, super alloy, or materials including carbon nanofoam CNFs, or alternate carbon nanofoam inductor ACNFI fillers and adhesive insulators cools or cures then both extruded halves are removed and stored. The remainder halves with highly pure metal, super alloy, or materials including carbon nanofoam CNFs, or alternate carbon nanofoam inductor ACNFI fillers and adhesive insulators are then joined and prepared for a second molten fill of greater than 0% to less than 100% highly pure metal, super alloy, or materials including carbon nanofoam CNFs, or alternate carbon nanofoam inductor ACNFI fillers and adhesive insulators. After the fill is cooled the whole part is removed from the cast halves and may be inspected, deburred, and/or finished.

The variable hydraulic preform slurry non ionic or electrolyte mechanically refined and nanoparticle dispersion high wear-heat resistant parts press FIG. 1 numbers 1 to 18. The 1-Hydraulic control wheel is connected to the 2-Electronic servo and allows the operator to expand and contract 7-Slurry non ionic and electrolyte tool steel press plate primarily to expand the 10-Slurry non ionic and electrolyte tool steel reservoir by moving the 1-Hydraulic control wheel in a fully counter clockwise fashion. This allows the operator to initiate a separate machine to pump Slurry non ionic and electrolyte into the 8-Slurry non ionic and electrolyte tool steel line in, subsequently to the 9-Gravity feed collector line out and finally to the 10-Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys manufactured preform slurry non ionic or electrolyte mechanically refined and nanoparticle high wear-heat resistant parts. After the 10-Slurry non ionic and electrolyte tool steel reservoir is filled the operator can electronically disengage or manually remove the manual stop control release pull pin. The operator then closes the 9B-Tool steel control to prepare for the extrusion. The operator would proceed by rotating the 1-Hydraulic control wheel in a clockwise fashion contracting the 7-Slurry non ionic and electrolyte tool steel press plate and forcing the Slurry non ionic and electrolyte comprised of non ionic or electrolyte mechanically refined and nanoparticle slurry formula into the 17-Tool steel extrusion die cast design internal cavity. The specified amount of Slurry non ionic and electrolyte is compressed to preform slurry non ionic or electrolyte mechanically refined and nanoparticle specification pressure measured in mili bars Mb until the specified Slurry non ionic and electrolyte required to fill the 17-Tool steel extrusion die cast design internal cavity has been reached. The 1-Hydraulic control wheel is then locked until the 17-Tool steel extrusion die cast design internal cavity has been removed.

The 2-Electronic servo sends an electrical signal to the 3-Hydraulic pump of the 7-Slurry non ionic and electrolyte tool steel press plate position that is calibrated to the 1-Hydraulic control wheel.

The 3-Hydraulic pump receives an electrical signal from the 2-Electronic servo of the 7-Slurry non ionic and electrolyte tool steel press plate position that is calibrated to the 1-Hydraulic control wheel. The 3-Hydraulic pump pumps fluids to the 4-Hydraulic pipe.

The 4-Hydraulic pipe receives fluids from the 3-Hydraulic pump and conveys the fluids to the 5-Hydraulic actuator.

The 5-Hydraulic actuator receives fluids from the 4-Hydraulic pipe and the force from the fluids is transferred through the actuator as vertical up-and-down movement to an affixed 6-Hydraulic arm.

The 6-Hydraulic arm moves vertically up-and-down and forces the 7-Slurry non ionic and electrolyte tool steel press plate to expand and contract.

The 7-Slurry non ionic and electrolyte tool steel press plate is forced by the 6-Hydraulic arm to expand and contract.

The 8-Slurry non ionic and electrolyte tool steel line in receives Slurry non ionic and electrolyte from an external pump and conveys them to the 9A-Gravity feed tool steel collector. The 8-Slurry non ionic and electrolyte tool steel line in can be ionic process tool steel interface positive or negative electrode electronically charged for enhanced formulation.

The 9A-Gravity feed tool steel collector receives Slurry non ionic and electrolyte from the 8-Slurry non ionic and electrolyte tool steel line in and conveys them to the 10-Slurry non ionic and electrolyte tool steel reservoir.

The 10-Slurry non ionic and electrolyte tool steel reservoir receives Slurry non ionic and electrolyte from the 9A-Gravity feed tool steel collector line out.

After the 10-Slurry non ionic and electrolyte tool steel reservoir is filled the 9B-Tool steel control is utilized to close the opening to prepare for the extrusion and may be provisionally locked and stopped at any position.

The 11-Slurry non ionic and electrolyte reservoir regulated tool steel waste filter removes waste from the 10-Slurry non ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in mili bars Mb, and fractional distillation all waste gases are processed to flu gas detoxification system.

The 12-Slurry non ionic and electrolyte reservoir expanded.

The 13-Slurry non ionic and electrolyte reservoir contracted.

The 14-Slurry non ionic and electrolyte reservoir brass or tool steel aperture and 15-Tool steel extrusion die cast design brass or tool steel fitting connects directly and conveys Slurry non ionic and electrolyte to the 17-Tool steel extrusion die cast design internal cavity. The 18-Tool steel extrusion die cast design internal cavity regulator waste filter and 18B-Tool steel vacuum release control and portal works in unison with the press plate drawing expanding and contracting Slurry non ionic and electrolyte removing waste from the 17-Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in mili bars Mb, and fractional distillation all waste gases are processed to flu gas detoxification system.

The 17-Tool steel extrusion die cast internal cavity is designed as a tool steel extrusion die cast mold for each highly pure carbon and carbon nanofoam CNFs fillers and adhesive insulators part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 31 to supplement the development of extrusion die cast master design manufacture process with high purity tool steel die cast extrusion molds. Highly pure carbon, carbon nanofoam CNFs, and alternate carbon nanofoam inductor ACNFI fillers and adhesive insulators brake pads, electronic brushes and parts require two master extrusions tool steel mold halves for each specification part. Highly pure carbon, carbon nanofoam CNFs, and alternate carbon nanofoam inductor ACNFI fillers and adhesive insulators parts precision casting molds requires a minimum two and a maximum of six master extrusion tool steel mold halves for each specification part.

Highly pure carbon, carbon nanofoam CNFs, and alternate carbon nanofoam inductor ACNFI fillers and adhesive insulators parts precision casting molds are utilized to manufacture highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators 1.0 to 2.5 phase extrusions and two to six master Highly pure carbon, carbon nanofoam CNFs, and alternate carbon nanofoam inductor ACNFI fillers and adhesive insulators mold halves per specification part.

The manufacture process of 1.0 to 2.5 phase extrusions and die cast design for highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators requires two to six master extrusion tool steel halves for each two to six reciprocal highly pure carbon, carbon nanofoam CNFs, and alternate carbon nanofoam inductor ACNFI fillers and adhesive insulators master precision casting molds parts allowing two A and B highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators to be combined. The 0.5 phase extrusion equals two die cast mold halves both equal to or less than one half 0.5 phase extrusion molten pour.

The utility patent application specification concrete control room and monitoring station manufacturing in a complete vacuum and may supply rich oxygen from capillary feeders at varying points to the specified highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part molten fill A and B fills up to four pours. The highly pure carbon, carbon nanofoam CNFs, and alternate carbon nanofoam inductor ACNFI fillers and adhesive insulators half shell or 0.5 phase extrusion are designed and utilized for state of the art manufacture process when combining highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators in combination of layered foundry fills, parts may be sprayed and dipped non conductive adhesives insulator films, and all waste gases are processed to flu gas detoxification system.

The highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators is a layered greater than 0% to less than 100% alloy component A and greater than 0% to less than 100% alloy component B part that is created in combination of layered foundry fills by utilizing two to six master Highly pure carbon, carbon nanofoam CNFs, and alternate carbon nanofoam inductor ACNFI fillers and adhesive insulators parts precision casting molds per specification part by pouring molten fill as a layered alloying component highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators four molten metal or other fill pours equal to 1.0 to 2.5 phase extrusions.

The highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators is a layered greater than 0% to less than 100% highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators A component part, and greater than 0% to less than 100% highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators B component part created in combination of layered fills of two to six master Highly pure carbon, carbon nanofoam CNFs, and alternate carbon nanofoam inductor ACNFI fillers and adhesive insulators extrusion die cast mold halves equal to 1.0 to 2.5 phase extrusions.

Super carbon alloy is defined as carbon nanofoam CNFs sintered and/or smeltered foundry manufacture process of combined highly pure metal, super alloy, and/or element. The pre and post pour technological standard is accomplished with the utility patent application specification concrete control room and monitoring station manufacturing in a complete vacuum and may supply rich oxygen from capillary feeders at varying points and all waste gases are processed to flu gas detoxification system and includes nitrate, nitride, anodize, and benzotriazole, methyl, tolyltriazole, sodium chemical pre and post foundry treatment submersion bath flake and prill anticorrosive purification solution washing and screening table for the manufacture of copper and metals. Hot smelters prepare iron, manganese, lithium, cadmium, lead, nickel, copper, zinc, zirconium, aluminum, titanium, molybdenum, tungsten, or metal for die cast pours and are also utilized for layered foundry fills die cast pours of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator.

All mechanically refined metal ore may be sintered and/or smeltered element additive alloyed carbon nanofoam CNFs, tolyltriadole, sodium, benzotriadole, methyl, ammoniate, galvanize, anodize, nitrate, molybdenum, chromium, chromoloy, nitride, hydrochloric acid or combined alloyed sintered and/or smeltered highly pure metal, super alloy, alkaline, nonconductive zirconia, and impedance matching load or signal ceramic red brick clay insulator.

All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase design extrusion die cast molding for super alloy. The super alloy is a layered greater than 0% to less than 100% highly pure metal or super alloy and greater than 0% to less than 100% highly pure metal or super alloy part that is created by pouring molten metal into a cast mold over a process of 2.5 phase design extrusion that create four molded casts for each designed master steel part that is manually machined and manufactured named part X the external layer highly pure metal or super alloy and part Z the internal layer highly pure metal or super alloy.

This replacement mold application is for the manufactured process of 2.5 phase design extrusion that creates a single part identical to the master designed and machined manufactured part. The new part chemical element becomes a super alloy that is layered greater than 0% to less than 100% highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator and greater than 0% to less than 100% highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator. The manufacture process begins by a designed and machined manufactured master part named part X. The master part X is used to create two external cast halves. This is accomplished by casting the master part X into the center of two ceramic molded halves with newly poured ceramic slip and then may be placed in a cool damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit.

The second master part named part Z is designed and machined manufactured greater than 0% to less than 100% less than tolerances that of the master part X or the external cast halves. The master part Z is used to create two internal cast halves. This is accomplished by casting the master part Z into the center of two ceramic molded halves with newly poured ceramic slip and then may be placed in a cool damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by pouring ceramic slip into the recesses and joining both halves with new cast covers to dry.

The external tolerances of all of the four cast covers X and Z are identical opposing so that X and Z halves can be joined and prepared for two separate halves molten highly pure metal or super alloy fills. After the poured molten highly pure metal or super alloy cools both extruded halves are removed and stored. The remainder halves with highly pure metal or super alloy fills are then joined and prepared for a second molten fill of greater than 0% to less than 100% highly pure metal or super alloy.

After the highly pure metal or super alloy is cooled the whole part is removed from the cast halves and is inspected, deburred, and finished.

The 14-Slurry non ionic and electrolyte reservoir brass or tool steel aperture conveys Slurry non ionic or electrolyte mechanically refined and nanoparticle to the 17-Tool steel extrusion die cast design internal cavity. Slurry non ionic or electrolyte mechanically refined and nanoparticle samples are taken and photo spectrometry analyzed by optical absorption, Raman spectra, and scanning electron microscopy measured in nanometers Nm to enhance slurry formula.

The 16-Tool steel electronic servo or manual stop control release pull pin can be electronically disengaged or manually removed after the 10-Slurry non ionic and electrolyte tool steel reservoir is filled to begin the Slurry non ionic and electrolyte extrusion.

The 18-Tool steel extrusion die cast design internal cavity regulator waste filter removes waste from the 17-Tool steel extrusion die cast design internal cavity while it is being filled with Slurry non ionic and electrolyte. The 18-Tool steel extrusion die cast design internal cavity regulator waste filter and 18B-Tool steel vacuum release control with processing may utilize an external vacuum pump for required specifications specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys.

The manufacture process of preform slurry non ionic or electrolyte mechanically refined and nanoparticle high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Preform slurry non ionic or electrolyte making of four sections 1. Preform slurry non ionic or electrolyte mechanically refined and nanoparticle high wear-heat resistant part 2. preform slurry non ionic or electrolyte mechanically refined and nanoparticle high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 3. preform slurry non ionic or electrolyte mechanically refined and nanoparticle high wear-heat resistant parts aerospace, automotive, and transportation brake calipers, rotors, pads, washers, spacers, and bushings 4. preform slurry non ionic or electrolyte mechanically refined and nanoparticle high wear-heat resistant parts precision casting molds for the manufacturing of highly pure metal, super alloy, highly pure carbon, ceramics, silica alumina, acid solids, alkalines, glass, acrylic, thermoplastic polymers, halide, alkalide, antimonide, nonconductive zirconia, carbon nanofoam CNFs, alternate carbon nanofoam inductor ACNFI, and impedance matching load or signal ceramic red brick clay insulators 1.0 to 2.5 phase extrusions two to six master preform slurry non ionic or electrolyte mechanically refined and nanoparticle high wear-heat resistant parts precision casting molds. All 2.5 phase extrusions and half shell castings are processed utility patent application specification concrete control room and monitoring station manufacturing in a complete vacuum and may supply rich oxygen from capillary feeders at varying points to molten elements in crucibles, and extrusion molds parts may be sprayed and dipped non conductive adhesives insulator films and all waste gases are processed to flu gas detoxification system.

Preform slurry non ionic or electrolyte mechanically refined and nanoparticle dispersion carbon nanofoam CNFs made by the Variable hydraulic preform slurry non ionic or electrolyte mechanically refined and nanoparticle dispersion high wear-heat resistant parts press FIG. 1 numbers 1 to 18. Variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of 6-Solids, 7-Liquids and 8-Gases Noble gaseous element Argon or other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys manufactured preform slurry non ionic or electrolyte mechanically refined and nanoparticle high wear-heat resistant parts.

Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators including two to six master extrusion halves 1.0 to 2.5 phase extrusions per specification part molten foundry fill up to four pours and the manufacture process or assembly for each specification component or part thereof and all waste gases are processed to flu gas detoxification system.

Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, or other metal drawing and annealing process for wire, spun cable, woven rebar mesh, with or without woven synthetic or natural fibers unit of measurement in gage trade name rebar cable, rebar mesh, and manufacture process connector system, including cable connectors, super alloy forge tool steel die cast tool, crimping tool works with manufacture process connector system rebar cable, rebar mesh, and connectors. Other construction tools include powders nitrate hardened trade name nitride steel grit unit of measurement in mesh or grit size, and manufacturing of carbon nanofoam CNFs super alloy trade name super alloy.

Utility patent application specification concrete control room and monitoring station manufacturing in a complete vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system.

Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system.

Utility patent application specification concrete control room and monitoring station manufacturing in a complete vacuum and may supply rich oxygen from capillary feeders at varying points to mechanically refined metal ore sintered and smeltered non metallic additive carbon nanofoam CNFs alloyed trade name super alloy, steel trade name super carbon steel, tungsten trade name super carbon tungsten, or additive sintered and smeltered molybdenum for homogenization steel trade name molybdenum steel, or tungsten trade name molybdenum tungsten and all waste gases are processed to flu gas detoxification system.

Utility patent application specification manufacturing of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator 1.0 to 2.5 phase extrusions or half shell casted composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI six sides rectangle, or square, or three sides continuous rod or cylinder highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI, or three sides zircon cutting tools, or two sides continuous for drill bits half shell casted tools measured in gage.

Utility patent application specification manufacturing of highly pure metal or super alloy forge tool steel die cast tool, crimping tool for trade name rebar cable and manufacture process connector system, specific tool steel parts that conform to specified requirements to unique American Society for Testing and Materials International Standards Worldwide Identifiers variable hydraulic preform slurry non ionic or electrolyte mechanically refined and nanoparticle dispersion high wear-heat resistant parts press FIG. 1 numbers 1 to 18 and tool steel tungsten die cast extrusion molds for with manufacturing highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI.

Utility patent application specification manufacture process of replacement ceramic precision casting molds specification number 31 for with manufacturing highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI.

Utility patent application specification manufacture process of preform slurry non ionic or electrolyte mechanically refined and nanoparticle dispersion carbon nanofoam CNFs with or without ionic suspension element Specification 50 elements or Specification 51 alloys extrusion or casted highly pure metal, super alloy, carbon nanofoam CNFs with or without ionic suspension element Specification 50 elements, Specification 51 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminals measured in Volts, or of preform slurry non ionic or electrolyte alternate carbon nanofoam inductor ACNFI extrusion, or casted highly pure metal, super alloy, alternate carbon nanofoam inductor ACNFI, nonconductive zirconia, and impedance matching load or signal ceramic red brick clay insulator electronic part equivalent to one resistor, switch, relay, or electronic part inductor, antinode coupler, and ground series and parallel circuits two negative terminals measure in 0 hms of inductor, antinode coupler, and ground or two positive and negative terminals measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, carbon nanofoam CNFs, or alternate carbon nanofoam inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminals measured in Volts or two negative terminals measured in 0 hms to antinode coupler, or continuous rod or cylinder three sides, one continuous side nonconductive zirconia, impedance matching load or signal ceramic red brick clay insulator, carbon nanofoam CNFs, or alternate carbon nanofoam inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminals measured in Volts or two negative terminals measured in 0 hms to antinode coupler preform slurry non ionic or electrolyte casted ionic suspension element carbon nanofoam CNFs battery cell outstanding one or two sides plate, sheet, foil, or leaf casted conductive highly pure metal, super alloy, halide, antimonide, or alkalide series and parallel circuits and two positive and negative terminals measured in Volts or two negative terminals measured in 0 hms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminals measured in Volts or two negative terminals measured in 0 hms to antinode coupler.

Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Battery with or without lightweight super impregnated gaseous element suspension halogen, antimony, or highly pure ammonia with or without ionic suspension element carbon nanofoam CNFs, alternate carbon nanofoam inductor ACNFI, Nano alumina, alumina, and ionic suspension element Specification 50 highly pure metals or ionic suspension element Specification 51 super alloys. Battery crucible casted conductive or 1.0 to 2.5 phase extrusions highly pure metal or super alloy layered, and interval spaced series and parallel circuits and/or complex, crucible casted conductive or 1.0 to 2.5 phase extrusions Variable hydraulic preform slurry non ionic silicate alumina carbon nanofoam CNFs dispersion high wear-heat compression resistant light weight battery cells. Highly pure alkali silica, alumina, Nano alumina, or elements lithium, cadmium, nickel, lead, copper, Specification 50 elements or Specification 51 alloys. One by one each battery cell crucible casted non conductive or submersion bath thermoplastic polymer sealed control room vacuum protocol manufacture process. Motor frame protected by synthetic woven textile fiber, silica fiber high heat-resistant insulator shielding, preform slurry non ionic silicate carbon nanofoam CNFs dispersion high wear-heat compression resistant light weight insulator, and/or or high tensile strength super alloy woven textile shielding. One by one each battery cell crucible casted or submersion bath thermoplastic polymer sealed control room vacuum protocol manufacture process. All four conductive or non conductive heat-wear high tensile strength and compression resistant insulators are designed and built in monocomb and corrugated compartmented composite combinations thermoplastic sealed, layered or woven shielded.

Motor crucible casted or 1.0 to 2.5 phase extrusions highly pure metal or super alloy composite coils, composite windings, and alumina, copper, wire annealing, drawing, and spun coils or other highly pure metal including highly pure metal or super alloy drawing and annealing process for wire. Motor composite coils, composite windings usually copper or super alloy includes continuous or numeric interval spools shapes of rod, cylinder, sphere, rectangle, or square crucible casted or 1.0 to 2.5 phase extrusions. Motor electronic components brushes carbon nanofoam CNFs with or without ionic suspension elements each brush alternate carbon nanofoam inductors, and antinode coupler continuous or numeric ramps positive and negative terminal measured in Volts and monitors positive and negative terminal measured in Volts and negative and negative terminals measure in 0 hms of inductor, antinode coupler, and ground series and parallel circuits. Spun numeric wrapped super alloy copper wire are thermoplastic polymer dipped or protected synthetic woven fibers, silica woven fibers, or high tensile strength super alloy carbon nanofoam CNFs shielding. Motor frame protected by synthetic woven textile fiber, silica fiber high heat-resistant insulator shielding, preform slurry non ionic silicate carbon nanofoam CNFs dispersion high wear-heat compression resistant light weight insulator, and/or or high tensile strength super alloy woven textile shielding. One by one all composite or wire motor coils and windings are crucible casted or submersion bath thermoplastic polymer sealed control room vacuum protocol manufacture process. Three heat-wear high tensile strength and Variable hydraulic preform slurry non ionic silicate carbon nanofoam CNFs dispersion high wear-heat compression resistant light weight insulators are designed and built in monocomb and corrugated compartmented composite combinations thermoplastic sealed, layered or woven shielded. Crucible casted or 1.0 to 2.5 phase extrusions motor rods, bearings, casings, housings, and assemblies are manufactured and assembled.

Visible light enters the lightweight universal spectra camera and monitor panel shell optical glass lens of added and subtracted magnification lenses travelling to scientific mirror reflecting visible light onto analogous photo electron active chemical film and lightweight universal spectra camera and monitor panel shell photo reflector and receptor precision silica alumina glass or thermoplastic polymer beads. The precision silica alumina glass or thermoplastic polymer beads occupy vertical and horizontal panel shell segments of the universal spectra camera and monitor panel shell receiving visible light. Numbered sums of reflected delineations from precision silica alumina glass or thermoplastic polymer beads emitters of visible light spectra waveform frequency onto thermoplastic polymer sealed fiber optic cables process in nanoseconds spectra waveform frequency to central processing unit CPU waveform generator frequency counters and analyzers of waveform frequency added and subtracted changes of the order of wavenumber data output in nanoseconds spectra waveform frequency pure light, filtered light, colored light, and reflective light electronic storage medium random access memory RAM and writable random access memory WRAM compact disc. Numbered sums of reflected centers from precision silica alumina glass or thermoplastic polymer beads emitters of visible light spectra waveform frequency onto thermoplastic polymer sealed fiber optic cables process in nanoseconds spectra waveform frequency to central processing unit CPU waveform generator frequency counters and analyzers of waveform frequency added and subtracted changes of the order of wavenumber data output in nanoseconds spectra waveform frequency pure light, filtered light, colored light, and reflective light electronic storage medium random access memory RAM and writable random access memory WRAM compact disc. The central processing unit CPU waveform generator spectra monitor random access memory RAM data input is received by central processing unit CPU waveform generator processor of spectra waveform frequency added and subtracted changes of the order of wavenumber data output in nanoseconds spectra waveform frequency numbered emitters of pure light, filtered light, colored light, and reflective light onto fiber optic cables and analogous precision silica alumina glass or thermoplastic polymer beads emitters of pure light, filtered light, colored light, and reflective light numbered segments of the monitor panel shell equal to the vertical and horizontal picture resolution. The universal spectra monitor panel shell precision silica alumina glass or thermoplastic polymer beads numbered segments of the polarized optical silica alumina glass panel or thermoplastic polymer shell is finished with touch screen kiosk vertical and horizontal annealing, drawing, and spun pressed strips of highly pure metal alumina and alternate carbon nanofoam inductor ACNFI negative electron molecules touch screen kiosk sensory cells printed conductive series and parallel circuits shielded cables process in nanoseconds negative electron molecules waveform frequency to central processing unit CPU waveform generator added and subtracted changes of the order of wavenumber data output in nanoseconds negative electron molecules waveform frequency. The pure light, filtered light, colored light, and reflective light data output spectra waveform frequency is received by central processing unit CPU waveform generator printer of pure light, filtered light, colored light, and reflective light scale ink composite printed film.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B—Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—Tl—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—Rg—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire, Al—Li aluminum, lithium, sometimes mercury, Alnico aluminum, nickel, copper, Duralumin copper, aluminum, Magnalium aluminum, 5% magnesium, Magnox magnesium oxide, aluminum, Nambe aluminum plus seven other unspecified metals, Silumin aluminum, silicon, and Zamak zinc, aluminum, magnesium, copper, Aluminum forms other complex alloys with magnesium, manganese, and platinum. Bismuth Alloys Wood's metal bismuth, lead, tin, cadmium, Rose metal bismuth, lead, tin, Field's metal, and Cerrobend. Cobalt Alloys Megallium, and Stellite cobalt, chromium, tungsten or molybdenum, carbon Talonite cobalt, chromium. Ultimet cobalt, chromium, nickel, molybdenum, iron, tungsten, and Vitallium. Copper Alloys Arsenical copper, Beryllium copper, beryllium, and Billon copper, silver. Brass copper, zinc, Calamine brass copper, zinc, Chinese silver copper, zinc, Dutch metal copper, zinc, Gilding metal copper, zinc, Muntz metal copper, zinc, Pinchbeck copper, zinc, Prince's metal copper, zinc, and Tombac copper, zinc. Bronze copper, tin, aluminum or other element, Aluminum bronze copper, aluminum, Arsenical bronze copper, arsenic, Bell metal copper, tin, Florentine bronze copper, aluminum or tin, Glucydur beryllium, copper, iron, Guanin likely a manganese bronze of copper, manganese, with iron sulfides and other sulfides, Gunmetal copper, tin, zinc, Phosphor bronze copper, tin and phosphorus, Ormolu Gilt Bronze copper, zinc, and Speculum metal copper, tin. Constantan copper, nickel, Copper-tungsten copper, tungsten, Corinthian bronze copper, gold, silver, Cunife copper, nickel, iron, Cupronickel copper, nickel, Cymbal alloys Bell metal copper, tin, Devarda's alloy copper, aluminum, zinc, Electrum copper, gold, silver, Hepatizon copper, gold, silver, Heusler alloy copper, manganese, tin, Manganin copper, manganese, nickel, Nickel silver copper, nickel, Nordic gold copper, aluminum, zinc, tin, Shakudo copper, gold, and Tumbaga copper, gold. Gallium Alloys Galinstan gallium, indium, tin. Gold Alloys Electrum gold, silver, copper, Tumbaga gold, copper, Rose gold, copper, and White gold, nickel, palladium, or platinum. Indium Alloys Field's metal indium, bismuth, tin. Iron or Ferrous Alloys Steel carbon Stainless steel chromium, nickel, AL-6XN, Alloy 20, Celestrium, Marine grade stainless, Martensitic stainless steel, and Surgical stainless steel chromium, molybdenum, nickel. Silicon steel silicon, Tool steel tungsten or manganese, Bulat steel, Chromoly chromium, molybdenum, Crucible steel, Damascus steel, HSLA steel, High speed steel, Maraging steel, Reynolds 531, and Wootz steel. Iron Anthracite iron carbon, Cast iron carbon, Pig iron carbon, and Wrought iron carbon. Fernico nickel, cobalt, Elinvar nickel, chromium, Invar nickel, Kovar cobalt, and Spiegeleisen manganese, carbon, silicon. Ferroalloys Ferroboron, Ferrochrome chromium, Ferromagnesium, Ferromanganese, Ferromolybdenum, Ferronickel, Ferrophosphorus, Ferrotitanium, Ferrovanadium, and Ferrosilicon. Lead Alloys Antimoniallead, antimony, Molybdochalkos lead, copper, Solder lead, tin, Terne lead, tin, and Type metal lead, tin, antimony. Magnesium Alloys Magnox magnesium, aluminum T—Mg—Al—Zn Bergman phase, and Elektron. Mercury Alloys Amalgam mercury and other metal except platinum. Nickel Alloys Alumel nickel, manganese, aluminum, silicon, Chromel nickel, chromium, Cupronickel nickel, bronze, copper, German silver nickel, copper, zinc, Hastelloy nickel, molybdenum, chromium, sometimes tungsten, Inconel nickel, chromium, iron, Monel metal copper, nickel, iron, manganese, Mu-metal nickel, iron, Ni—C nickel, carbon, Nichrome chromium, iron, nickel, Nicrosil nickel, chromium, silicon, magnesium, Nisil nickel, silicon, and Nitinol nickel, titanium, shape memory alloy. Potassium Alloys KLi potassium, lithium, and NaK sodium, potassium. Rare Earth Alloys Mischmetal various rare earths. Silver Alloys Argentium sterling silver, copper, germanium, Billon copper or copper bronze, sometimes with silver, Britannia silver, copper, Electrum silver, gold, Goloid silver, copper, gold, Platinum sterling silver, platinum, Shibuichi silver, copper, and Sterling silver, copper. Tin Alloys Britannium tin, copper, antimony, Pewter tin, lead, copper, and Solder tin, lead, antimony. Titanium Alloys Beta C titanium, vanadium, chromium, other metals, and 6al-4-v titanium, aluminum, vanadium. Uranium Alloys Staballoy depleted uranium with titanium or molybdenum, and Uranium may also be alloyed with plutonium. Zinc Alloys Brass zinc, copper, and Zamak zinc, aluminum, magnesium, copper. Zirconium Alloys Zircaloy zirconium and tin, sometimes with niobium, chromium, iron, nickel.

1. Preform slurry non ionic or electrolyte mechanically refined and nanoparticle dispersion carbon nanofoam CNFs made by variable hydraulic preform slurry non ionic or electrolyte mechanically refined and nanoparticle dispersion high wear-heat resistant parts press The variable hydraulic press and distillation reservoir manufacture process scientific formula non ionic or electrolyte mechanically refined and nanoparticle, carbon nanofoam CNFs dispersion preform slurry extrusion, with or without ionic suspension element for manufactured 1. preform slurry high wear-heat resistant parts electronic component composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, electronic resistors, transformers, transducers, rectifiers, power supplies, or heat sinks 2. preform slurry high wear-heat resistant parts aerospace, automotive, and transportation brake calipers, rotors, pads, and bushings 3. preform slurry non ionic or electrolyte mechanically refined and nanoparticle high wear-heat resistant parts precision casting molds 2.5 phase die cast molding and 4. Building Materials preform slurry non ionic or electrolyte mechanically refined and nanoparticle dispersion fine concrete, mortar, brick, and tiles. The variable hydraulic preform slurry non ionic or electrolyte mechanically refined and nanoparticle dispersion high wear-heat resistant parts press with FIG. 1 numbers 1 to 18 specific components that conform to specified requirements to unique American Society for Testing and Materials International Standards Worldwide Identifiers. Variable hydraulic preform slurry non ionic or electrolyte mechanically refined and nanoparticle dispersion high wear-heat resistant parts press the center of the utility patent application specification slurry formula in three scientific forms of Solids, Liquids and Gases Noble gaseous element Argon or other gaseous element specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys manufactured preform slurry non ionic or electrolyte mechanically refined and nanoparticle high wear-heat resistant parts. The variable hydraulic preform slurry non ionic or electrolyte mechanically refined and nanoparticle dispersion high wear-heat resistant parts press FIG. 1 numbers 1 to 18. The 1-Hydraulic control wheel is connected to the 2-Electronic servo and allows the operator to expand and contract 7-Slurry non ionic and electrolyte tool steel press plate primarily to expand the 10-Slurry non ionic and electrolyte tool steel reservoir by moving the 1-Hydraulic control wheel in a fully counter clockwise fashion. This allows the operator to initiate a separate machine to pump Slurry non ionic and electrolyte into the 8-Slurry non ionic and electrolyte tool steel line in, subsequently to the 9-Gravity feed collector line out and finally to the 10-Slurry non ionic and electrolyte tool steel reservoir. Slurry non ionic and electrolyte is defined here as specified scientific formula liquid and gaseous mechanically refined and nanoparticle dispersion preform slurry non ionic or electrolyte, solids, liquids and/or gases, heated, chilled, or room temperature chemical non ionic groups of amphoteric polysaccharide linear or branched alkyl compounds or electrolyte ionic melts, ionic fluids, and/or fused, and/or catalyst acid and bases, actual catalyst, and/or catalyst reservoir with or without ionic suspension element Specification 50 elements and/or Specification 51 alloys manufactured preform slurry non ionic or electrolyte mechanically refined and nanoparticle high wear-heat resistant parts. After the 10-Slurry non ionic and electrolyte tool steel reservoir is filled the operator can electronically disengage or manually remove the manual stop control release pull pin. The operator then closes the 9B-Tool steel control to prepare for the extrusion. The operator would proceed by rotating the 1-Hydraulic control wheel in a clockwise fashion contracting the 7-Slurry non ionic and electrolyte tool steel press plate and forcing the Slurry non ionic and electrolyte comprised of non ionic or electrolyte mechanically refined and nanoparticle slurry formula into the 17-Tool steel extrusion die cast design internal cavity. The specified amount of Slurry non ionic and electrolyte is compressed to preform slurry non ionic or electrolyte mechanically refined and nanoparticle specification pressure measured in mili bars Mb until the specified Slurry non ionic and electrolyte required to fill the 17-Tool steel extrusion die cast design internal cavity has been reached. The 1-Hydraulic control wheel is then locked until the 17-Tool steel extrusion die cast design internal cavity has been removed. The 2-Electronic servo sends an electrical signal to the 3-Hydraulic pump of the 7-Slurry non ionic and electrolyte tool steel press plate position that is calibrated to the 1-Hydraulic control wheel. The 3-Hydraulic pump receives an electrical signal from the 2-Electronic servo of the 7-Slurry non ionic and electrolyte tool steel press plate position that is calibrated to the 1-Hydraulic control wheel. The 3-Hydraulic pump pumps fluids to the 4-Hydraulic pipe. The 4-Hydraulic pipe receives fluids from the 3-Hydraulic pump and conveys the fluids to the 5-Hydraulic actuator. The 5-Hydraulic actuator receives fluids from the 4-Hydraulic pipe and the force from the fluids is transferred through the actuator as vertical up-and-down movement to an affixed 6-Hydraulic arm. The 6-Hydraulic arm moves vertically up-and-down and forces the 7-Slurry non ionic and electrolyte tool steel press plate to expand and contract. The 7-Slurry non ionic and electrolyte tool steel press plate is forced by the 6-Hydraulic arm to expand and contract. The 8-Slurry non ionic and electrolyte tool steel line in receives Slurry non ionic and electrolyte from an external pump and conveys them to the 9A-Gravity feed tool steel collector. The 8-Slurry non ionic and electrolyte tool steel line in can be ionic process tool steel interface positive or negative electrode electronically charged for enhanced formulation. The 9A-Gravity feed tool steel collector receives Slurry non ionic and electrolyte from the 8-Slurry non ionic and electrolyte tool steel line in and conveys them to the 10-Slurry non ionic and electrolyte tool steel reservoir. The 10-Slurry non ionic and electrolyte tool steel reservoir receives Slurry non ionic and electrolyte from the 9A-Gravity feed tool steel collector line out. After the 10-Slurry non ionic and electrolyte tool steel reservoir is filled the 9B-Tool steel control is utilized to close the opening to prepare for the extrusion and may be provisionally locked and stopped at any position. The 11-Slurry non ionic and electrolyte reservoir regulated tool steel waste filter removes waste from the 10-Slurry lion ionic and electrolyte tool steel reservoir while it is being filled with Slurry non ionic and electrolyte from common recovery distillation heated interface tool steel and thermometer gauge, ordinary atmospheric pressure, vacuum pump barometric pressure measured in mili bars Mb, and fractional distillation all waste gases are processed to flu gas detoxification system. The 12-Slurry non ionic and electrolyte reservoir expanded. The 13-Slurry non ionic and electrolyte reservoir contracted. The 14-Slurry non ionic and electrolyte reservoir brass or tool steel aperture and 15-Tool steel extrusion die cast design brass or tool steel fitting connects directly and conveys Slurry non ionic and electrolyte to the 17-Tool steel extrusion die cast design internal cavity. The 18-Tool steel extrusion die cast design internal cavity regulator waste filter and 18B-Tool steel vacuum release control and portal works in unison with the press plate drawing expanding and contracting Slurry non ionic and electrolyte removing waste from the 17-Tool steel extrusion die cast design internal cavity while it is being filled with Slurry non ionic and electrolyte from common recovery distillation heated interface tool steel and thermometer gauge, ordinary atmospheric pressure, vacuum pump barometric pressure measured in mili bars Mb, and fractional distillation all waste gases are processed to flu gas detoxification system. The 17-Tool steel extrusion die cast internal cavity is designed as a tool steel extrusion die cast mold for each highly pure carbon and carbon nanofoam CNFs fillers and adhesive insulators part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 31 to supplement the development of extrusion die cast master design manufacture process with high purity tool steel die cast extrusion molds. Highly pure carbon, carbon nanofoam CNFs, and alternate carbon nanofoam inductor ACNFI fillers and adhesive insulators brake pads, electronic brushes and parts require two master extrusions tool steel mold halves for each specification part. highly pure carbon, carbon nanofoam CNFs, and alternate carbon nanofoam inductor ACNFI fillers and adhesive insulators parts precision casting molds requires a minimum two and a maximum of six master extrusion tool steel mold halves for each specification part. highly pure carbon, carbon nanofoam CNFs, and alternate carbon nanofoam inductor ACNFI fillers and adhesive insulators parts precision casting molds are utilized to manufacture highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators 1.0 to 2.5 phase extrusions and two to six master highly pure carbon, carbon nanofoam CNFs, and alternate carbon nanofoam inductor ACNFI fillers and adhesive insulators mold halves per specification part. The manufacture process of 1.0 to 2.5 phase extrusions and die cast design for highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators requires two to six master extrusion tool steel halves for each two to six reciprocal highly pure carbon, carbon nanofoam CNFs, and alternate carbon nanofoam inductor ACNFI fillers and adhesive insulators master precision casting molds parts allowing two A and B highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators to be combined. The 0.5 phase extrusion equals two die cast mold halves both equal to or less than one half 0.5 phase extrusion molten pour. The utility patent application specification concrete control room and monitoring station manufacturing in a complete vacuum and may supply rich oxygen from capillary feeders at varying points to the specified highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part molten fill A and B fills up to four pours. The highly pure carbon, carbon nanofoam CNFs, and alternate carbon nanofoam inductor ACNFI fillers and adhesive insulators half shell or 0.5 phase extrusion are designed and utilized for state of the art manufacture process when combining highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators in combination of layered foundry fills, parts may be sprayed and dipped non conductive adhesives insulator films, and all waste gases are processed to flu gas detoxification system. The highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators is a layered greater than 0% to less than 100% alloy component A and greater than 0% to less than 100% alloy component B part that is created in combination of layered foundry fills by utilizing two to six master highly pure carbon, carbon nanofoam CNFs, and alternate carbon nanofoam inductor ACNFI fillers and adhesive insulators parts precision casting molds per specification part by pouring molten fill as a layered alloying component highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators four molten metal or other fill pours equal to 1.0 to 2.5 phase extrusions. The highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators is a layered greater than 0% to less than 100% highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators A component part, and greater than 0% to less than 100% highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators B component part created in combination of layered fills of two to six master highly pure carbon, carbon nanofoam CNFs, and alternate carbon nanofoam inductor ACNFI fillers and adhesive insulators extrusion die cast mold halves equal to 1.0 to 2.5 phase extrusions. Distillation Reservoir and Recovery Basin super alloy and/or ceramics and/or highly pure carbon and carbon nanofoam CNFs fillers and adhesive insulators and Variable hydraulic press plate 1.0 to 2.0 phase extrusions 1.0 polarized extrusion with positively and negatively molten charging distillation glass optical, lenses, and mirrors with or without silica sands, mineral sands, alumina, Nano alumina, highly pure carbon, alkalines, carbon nanofoam CNFs, alternate carbon nanofoam inductor ACNFI, gold, or platinum and 2.0 extrusion acrylic and thermoplastic polymers. Other distillation processing mechanically refined and nanoparticle preform slurry non ionic or electrolyte dispersion or molten highly pure metal, super alloy, highly pure carbon, carbon nanofoam CNFs, alternate carbon nanofoam inductor ACNFI, Nano alumina, alumina, silica alumina, silica mineral, mineral sands, heavy minerals, glass, acrylic, thermoplastic polymer, acid solid, impedance matching ceramic red brick insulator, molybdenum, ceramic zirconia, ceramic silica, ceramic clay, calcium carbonate, alkaline, minerals, including ionic suspension elements and ceramic silica mineral insulator for Specification 50 elements highly pure metal, and Specification 51 alloys. Distillation reservoir halogen, highly pure ammonia, and antimony battery and other gaseous suspension elements mechanically refined and nanoparticle carbon nanofoam CNFs, alternate carbon nanofoam inductor ACNFI, alumina, Nano alumina, nickel, cadmium, lithium, magnesium, lead, antimonide, halide, alkaline, acid solid, and alkalide distillation processing and/or for up to four molten pours 1.0 to 1.0 to 2.5 phase extrusions or preform slurry non ionic or electrolyte. Both processes molten pours and variable hydraulic press plate preform slurry non ionic or electrolyte mechanically refined and nanoparticle dispersion under vacuum control room scientific distillation ordinary atmospheric pressure less than ordinary atmospheric pressure catalyst gases other Specification 50 elements argon, carbon monoxide, carbon dioxide, or other gases mechanically refined or nanoparticle suspension catalyst greater or lesser than ordinary atmospheric pressure. Super alloy super cooling refrigeration vacuum pump and super alloy venturi curved or linear expression comprising a scientific aperture, a divergence measured in angulation, and a scientific aperture diffusion gaseous particle accelerator super cooling refrigeration deceleration with or without nanoparticle synthesizing laser ablation and multi-waveform ablation X, Y, And Z alignment and fractional vacuum distillation gaseous and/or positive and negative ionic charges recovery and super alloy and/or ceramics and/or highly pure carbon and carbon nanofoam CNFs fillers and adhesive insulators distillation reservoir variable hydraulic press plate expanded and contracted greater or lesser than ordinary atmospheric pressure distillation recovery fractional vacuum distillation gaseous and/or positive distillation and variable hydraulic press plate expanded and contracted greater or lesser than ordinary atmospheric pressure distillation recovery allotropes of 6 C carbon, carbon, solid, liquid, and gases chemical non ionic groups of amphoteric polysaccharide linear or branched alkyl compounds or electrolytes and/or liquid ions and/or ionic melts and/or fused and/or acid and bases catalyst and/or catalyst slurry reservoir 6 C allotropes of carbon and liquid and/or liquid vapors and/or gaseous electrolyte catalyst acids and solid materials highly pure metal, super alloy, highly pure carbon, carbon nanofoam CNFs, alternate carbon nanofoam inductor ACNFI, Nano alumina, alumina, silica alumina, silica mineral, mineral sands, heavy minerals, glass, acrylic, thermoplastic polymer, acid solid, impedance matching ceramic red brick insulator, molybdenum, ceramic zirconia, ceramic silica, ceramic clay, calcium carbonate, alkaline, minerals, including ionic suspension elements and ceramic silica mineral insulator for Specification 50 elements highly pure metal, and Specification 51 alloys for building materials trade name preform modular alkalines, clays, and sands for fine concrete, mortar, bricks, tiles, and high wear-heat resistant parts brushes, windings, coils, battery cells, electronic resistors, capacitors, brake pads, washers, spacers, bushings, annealing, drawn, spun, coils, windings, wire, woven textile mesh, shielding, and 1.0 to 2.5 phase extrusions die cast molding. Number 1. Building materials fine concrete and mortar is mixed in distillation reservoir under vacuum control with nitrogen liquid vapors and gaseous electrolyte mechanically refined mineral sands and heavy minerals dispersion. Preform modular fine concrete arrives in trucks readymade utilized with manufacture process connector system comprised of super alloy forge tool steel die cast tool, crimping tool with manufacture process connector system rebar cable, rebar mesh, and connectors that work with easy to build box framing techniques and preform modular fine readymade concrete poured directly from hydraulic pump on readymade truck. Ready mix mortar is packaged and distributed in specially made thermoplastic sealed injection molded preformed containers and airtight dispenser system. Number 2. Supplemental super alloy super cooling refrigeration vacuum pump and super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas super cooling super alloy or super alloy venturi. Number 3. Self contained carbon dioxide CO2 refrigeration unit commercial, residential, or portable super alloy vacuum pump drawing carbon dioxide CO2 gas through Insulated super alloy feeder tubes in a parallel circuit to separate super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas is then passed over super alloy and through cooling fan. Self contained carbon dioxide CO2 refrigeration unit commercial, residential, or portable super alloy vacuum pump rated alternating current AC or direct current DC drawing carbon dioxide CO2 gas through insulated super alloy feeder tubes in a parallel circuit to separate numeric super alloy venturi curved or linear expression comprising a scientific aperture, a divergence measured in angulation, and a scientific aperture diffusion carbon dioxide CO2 gaseous particle accelerator super cooling refrigeration deceleration temperature to less than −109 degrees Fahrenheit or −78.5 degrees Celsius carbon dioxide CO2 sublimated frozen gas passes over super alloy and through cooling fan. Numeric isolated super alloy cylinders in series and parallel thermo conductive circuits are connected to the refrigeration unit from super alloy connecting rods super cooling the outside walls of the cylinders. The outer cylinder cools activating an electronic air compressor rated alternating current AC or direct current DC filling the inner variable cylinders with compressed air providing diffusive compensation expanding the inner cylinders forcing the carbon dioxide CO2 filled outer cylinders through a continuous circuit of super alloy venturi curved or linear expression comprising a scientific aperture, a divergence measured in angulation, and a scientific aperture diffusion carbon dioxide CO2 gaseous particle accelerator super cooling refrigeration deceleration temperature to greater than −109 degrees Fahrenheit or −78.5 degrees Celsius carbon dioxide CO2 forming dry ice in the outer internal press plate mold and Super alloy, and/or ceramic, and carbon nanofoam CNFs, and alternate carbon cylinders. Number 4. Distillation and recovery basin automation mass production variable hydraulic nanofoam inductor ACNFI fillers and adhesive insulators pour aperture located in the center and hydraulic cylinder located on the right expanded and contracted for molten pouring highly pure metal printed circuits, super alloy including carbon nanofoam CNFs printed circuits nickel, cadmium, lithium, lead, antimonide, halide, alkalide, Specification 50 elements printed circuits, or Specification 51 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production crucible casted molten highly pure metal printed circuits, super alloy, carbon nanofoam CNFs printed circuits nickel, cadmium, lithium, lead, antimonide, halide, alkalide, Specification 50 elements printed circuits, or Specification 51 alloys printed circuits and/or ceramic insulator for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production variable hydraulic press plate mold and Super alloy, and/or ceramic, and carbon nanofoam CNFs, and alternate carbon nanofoam inductor ACNFI fillers and adhesive insulators pour aperture located in the center and hydraulic cylinder located on the right expanded and contracted for pouring non ionic or electrolyte preform slurry with mechanically refined and nanoparticle dispersion fine printing highly pure metal printed circuits, super alloy including carbon nanofoam CNFs printed circuits, carbon nanofoam CNFs printed circuits, alternate carbon nanofoam inductor ACNFI printed circuits, carbon nanofoam CNFs ionic suspension element printed circuits nickel, cadmium, lithium, magnesium, lead, antimonide, Specification 50 elements printed circuits, or Specification 51 alloys printed circuits and/or ceramic insulator for 1.0, and 2.0 phase extrusion plates, sheets, foil, and leaf central processing unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation and recovery basin automation mass production crucible casted non ionic or electrolyte preform slurry with mechanically refined or nanoparticle dispersion fine printing highly pure metal printed circuits, super alloy including carbon nanofoam CNFs printed circuits, carbon nanofoam CNFs printed circuits, alternate carbon nanofoam inductor ACNFI printed circuits, carbon nanofoam CNFs ionic suspension element printed circuits nickel, cadmium, lithium, magnesium, lead, antimonide, Specification 50 elements printed circuits, or Specification 51 Alloys printed circuits and/or ceramic for 1.0, and 2.0 phase castings plates, sheets, foil, and leaf central processing Unit CPU processor, relay, switch, or alternate carbon nanofoam inductor ACNFI electronic storage media data or series and parallel circuits and battery cell series and parallel circuits rated conductive and ceramic silica mineral insulator, or ceramic alumina silica carbon nanofoam CNFs insulator. Distillation reservoir interchangeable combinations of preform slurry non ionic, electrolyte, or molten ceramic and conductive circuits 2.0 extrusions or castings are accomplished for each specification part. Number 5. Manufacture process of 1.0 to 2.5 phase extrusions die cast molding for precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators. The precision casting of highly pure metal, super alloy, halide, alkalide, antimonide, ceramic, acid solid, alkaline, polarized glass, precision silica alumina glass or thermoplastic polymer beads; and carbon nanofoam CNFs, or alternate carbon nanofoam inductor ACNFI fillers and adhesive insulators is a layered greater than 0% to less than 100% precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators and greater than 0% to less than 100% other precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part that is created by pouring molten metal, alloy, halide, alkalide, antimonide, ceramic, glass, acid solid, alkaline, thermoplastic polymer, non molten formula ceramic slip, acid solid, alkaline, and preform slurry non ionic or electrolyte carbon nanofoam CNFs, or alternate carbon nanofoam inductor ACNFI fillers and adhesive insulators into a cast mold over a process of 1.0 to 2.5 phase extrusions that create two to six molded casts for each designed master tool steel part that is manually machined and manufactured named part X external layer highly pure metal, super alloy, halide, alkalide, antimonide, ceramic, glass, acid solid, alkaline, thermoplastic polymer, including preform slurry non ionic or electrolyte carbon nanofoam CNFs, or alternate carbon nanofoam inductor ACNFI fillers and adhesive insulators and Part Z the internal layer other highly pure metal, super alloy, halide, alkalide, antimonide, ceramic, glass, thermoplastic polymer, acid solid, alkaline, including preform slurry non ionic or electrolyte carbon nanofoam CNFs, or alternate carbon nanofoam inductor ACNFI fillers and adhesive insulators. Manufactured process of 1.0 to 2.5 phase extrusions die cast molding for precision casting of super alloy, ceramic, and material ultimately create a single part identical to the master designed and machine manufactured part with the exception to the chemical element is now a super alloy, super alloy ceramic, or super material that may be layered greater than 0% to less than 100% highly pure metal, super alloy, super material, including carbon nanofoam CNFs, or alternate carbon nanofoam inductor ACNFI fillers and adhesive insulators and greater than 0% to less than 100% other highly pure metal, super alloy, super material including carbon nanofoam CNFs, and alternate carbon nanofoam inductor ACNFI fillers and adhesive insulators. Processing molded halves sequence 1 to 9 of manufacture process 1.0 to 2.5 phase extrusions die cast molding for precision casting of highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators part X and part Z side profile not shown here of casting for part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 filled with molten on non molten formula materials including preform slurry non ionic or electrolyte carbon nanofoam CNFs, or alternate carbon nanofoam inductor ACNFI fillers and adhesive insulators sequence 9. The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace. The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten or non molten formula highly pure metal, super alloy, or material including carbon nanofoam CNFs, or alternate carbon nanofoam inductor ACNFI fillers and adhesive insulators fills. After the poured molten highly pure metal, super alloy, or materials including carbon nanofoam CNFs, or alternate carbon nanofoam inductor ACNFI fillers and adhesive insulators cools or cures then both extruded halves are removed and stored. The remainder halves with highly pure metal, super alloy, or materials including carbon nanofoam CNFs, or alternate carbon nanofoam inductor ACNFI fillers and adhesive insulators are then joined and prepared for a second molten fill of greater than 0% to less than 100% highly pure metal, super alloy, or materials including carbon nanofoam CNFs, or alternate carbon nanofoam inductor ACNFI fillers and adhesive insulators. After the fill is cooled the whole part is removed from the cast halves and may be inspected, deburred, and/or finished. Number 6. Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, super alloy, halide, alkalide, antimonide, ceramic, acid solid, alkaline, polarized glass, precision silica alumina glass or thermoplastic polymer beads, and carbon nanofoam CNFs, or alternate carbon nanofoam inductor ACNFI fillers and adhesive insulators including two to six master extrusion halves 1.0 to 2.5 phase extrusions per specification part molten foundry fill up to four pours and the manufacture process or assembly for each specification component or part thereof and all waste gases are processed to flu gas detoxification system. Number 7. Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, or other metal drawing and annealing process for wire, spun cable, woven rebar mesh, with or without woven synthetic or natural fibers unit of measurement in gage trade name rebar cable, rebar mesh, manufacture process connector system, including cable connectors, super alloy forge tool steel die cast tool, crimping tool works with manufacture process connector system rebar cable, rebar mesh, and connectors. Other construction tools include powders nitrate hardened trade name nitride steel grit unit of measurement in mesh or grit size, and manufacturing of carbon nanofoam CNFs super alloy trade name super alloy. Number 8. Utility patent application specification concrete control room and monitoring station manufacturing in a complete vacuum and may supply rich oxygen from capillary feeders at varying points to utility patent application specification 1.0 to 2.5 phase extrusions manufacturing of highly pure metal or super alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system. Number 9. Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system. Number 10. Utility patent application specification concrete control room and monitoring station manufacturing in a complete vacuum and may supply rich oxygen from capillary feeders at varying points to mechanically refined metal ore sintered and smeltered non metallic additive carbon nanofoam CNFs alloyed trade name super alloy, steel trade name super carbon steel, tungsten trade name super carbon tungsten, or additive sintered and smeltered molybdenum for homogenization steel trade name molybdenum steel, or tungsten trade name molybdenum tungsten and all waste gases are processed to flu gas detoxification system. Number 11. Utility patent application specification manufacturing of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator 1.0 to 2.5 phase extrusions or half shell casted composite coils, composite windings, annealing, drawn, spun, coils, windings, wire, woven textile mesh, shielding, brushes, inductors, antinode couplers, electric rheostats, starters, motors, alternators, generators, ionic suspension element enhanced composite coils, composite windings, annealing, drawn, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI six sides rectangle, or square, or three sides continuous rod or cylinder highly pure metal, super alloy, acid solid, alkaline, glass, acrylic, thermoplastic polymer, halide, alkalide, non conductive zirconia, impedance matching load or signal ceramic red brick clay insulator, carbon nanofoam CNFs, or alternate carbon nanofoam inductor ACNFI, or three sides zircon cutting tools, or two sides continuous for drill bits half shell casted tools measured in gage. Number 12. Utility patent application specification concrete control room and monitoring station manufacturing in a complete vacuum and may supply rich oxygen from capillary feeders at varying points to utility patent application specification manufacturing of highly pure metal, super alloy, carbon, ceramics, acid solid, alkaline, glass, acrylic, thermoplastic polymer, halide, alkalide, nonconductive zirconia, carbon nanofoam CNFs, alternate carbon nanofoam inductor ACNFI, and impedance matching load or signal ceramic red brick clay insulator hot pouring casting printing with molten foundry fill of die cast mold precision casting of bars, rods, plates, sheets, foil, leaf, alumina, copper, wire, annealing, drawing, and spun coils and windings for electronic component, or other metal drawing and annealing process for wire, spun cable, woven rebar mesh, with or without woven synthetic or natural fibers unit of measurement in gage trade name rebar cable, rebar mesh, and manufacture process connector system, including cable connectors, powders nitrate hardened trade name nitride steel grit unit of measurement in mesh or grit size and manufacturing of carbon nanofoam CNFs super alloy trade name super alloy. Number 13. Utility patent application specification manufacture process of replacement ceramic precision casting molds specification number 31 for with manufacturing highly pure metal, super alloy, acid solid, alkaline, glass, acrylic, thermoplastic polymer, halide, alkalide, nonconductive zirconia, impedance matching load or signal ceramic red brick clay insulator, carbon nanofoam CNFs, or alternate carbon nanofoam inductor ACNFI.

2. Electronic parts utility patent application specification manufacture process of preform slurry non ionic or electrolyte mechanically refined and nanoparticle dispersion carbon nanofoam CNFs with or without ionic suspension element Specification 50 elements or Specification 51 alloys extrusion or casted highly pure metal, super alloy, carbon nanofoam CNFs with or without ionic suspension element Specification 50 elements, Specification 51 alloys, and alkaline, halide, antimonide, or alkalide, nonconductive zirconia, and impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series and parallel circuits two positive and negative terminals measured in Volts, or of preform slurry non ionic or electrolyte alternate carbon nanofoam inductor ACNFI extrusion, or casted highly pure metal, super alloy, alternate carbon nanofoam inductor ACNFI, nonconductive zirconia, and impedance matching load or signal ceramic red brick clay insulator electronic part equivalent to one resistor, switch, relay, or electronic part inductor, antinode coupler, and ground series and parallel circuits two negative terminals measure in 0 hms of inductor, antinode coupler, and ground or two positive and negative terminals measured in Volts. All electronic parts two sides casted conductive plate, sheet, foil, or leaf highly pure metal, super alloy, halide, antimonide, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam inductor ACNFI, plate, sheet, foil, or leaf casted insulated, and one side layered or non layered conductive highly pure metal, super alloy, and/or alkaline, halide, antimonide, or alkalide, plate, sheet, foil, or leaf casted conductive, or four sides nonconductive zirconia, impedance matching load or signal ceramic red brick clay insulator, carbon nanofoam CNFs, or alternate carbon nanofoam inductor ACNFI casted plate, sheet, foil, or leaf insulated, and two conductive highly pure metal, super alloy, and/or alkaline, halide, antimonide, or alkalide, plate, sheet, foil, or leaf casted series and parallel circuits and two positive and negative terminals measured in Volts or two negative terminals measured in 0 hms to antinode coupler, or continuous rod or cylinder three sides, one continuous side nonconductive zirconia, impedance matching load or signal ceramic red brick clay insulator, carbon nanofoam CNFs, or alternate carbon nanofoam inductor ACNFI, plate, sheet, foil, or leaf casted insulated, and two sides conductive highly pure metal, super alloy, and/or alkaline, halide, antimonide, or alkalide, plate, sheet, foil, or leaf casted series and parallel circuits and two positive and negative terminals measured in Volts or two negative terminals measured in 0 hms to antinode coupler preform slurry non ionic or electrolyte casted ionic suspension element carbon nanofoam CNFs battery cell outstanding one or two sides plate, sheet, foil, or leaf casted conductive highly pure metal, super alloy, halide, antimonide, or alkalide series and parallel circuits and two positive and negative terminals measured in Volts or two negative terminals measured in 0 hms to antinode coupler or electronic parts requires one, or two, or more brushes in even intervals and two or more inductors and antinode couplers with one or two sides conductive plate, sheet, foil, or leaf casted highly pure metal, super alloy, halide, antimonide, or alkalide series and parallel circuits and two positive and negative terminals measured in Volts or two negative terminals measured in 0 hms to antinode coupler. Number 14. An electronic part light weight ceramic or alkali metal silica that is tetra methyl orthosilica carbon nanofoam CNFs trade name Silicate Alumina carbon nanofoam CNFs slurry non ionic clustered nanoparticles are achieved by heated or chilled interface 8-Slurry non ionic tool steel line in liquid dispersion heated tetra methyl orthosilica, methanol, and carbon nanofoam CNFs or liquid dispersion chilled polyvinyl alchohol PVA reinforcement, and Carbon Nanofoams CNFs networks in suspension drying over usually fifteen minutes result network light weight Silicate Carbon Nanofoams CNFs controllable, high purity, connectivity, strength, conductivity, and shape. Number 15. Battery crucible casted or 1.0 to 2.5 phase extrusions highly pure metal or super alloy battery cells layered, spaced and casted conductive in series and parallel circuits even or odd interval number combinations varying complex, battery cells highly pure acid solid chemical and/or highly pure chemical alkali solid complex, crucible casted conductive or 1.0 to 2.5 phase extrusions highly pure metal or super alloy layered and interval spaced conductive in series and parallel circuits. Battery with or without lightweight super impregnated gaseous element suspension halogen, antimony, or highly pure ammonia with or without ionic suspension element carbon nanofoam CNFs, alternate carbon nanofoam inductor ACNFI, Nano alumina, alumina, and ionic suspension element Specification 50 highly pure metals or ionic suspension element Specification 51 super alloys. Battery crucible casted conductive or 1.0 to 2.5 phase extrusions highly pure metal or super alloy layered, and interval spaced series and parallel circuits and/or complex, crucible casted conductive or 1.0 to 2.5 phase extrusions Variable hydraulic preform slurry non ionic silicate alumina carbon nanofoam CNFs dispersion high wear-heat compression resistant light weight battery cells. Highly pure alkali silica, alumina, Nano alumina, or elements lithium, cadmium, nickel, lead, copper, Specification 50 elements or Specification 51 alloys. One by one each battery cell crucible casted non conductive or submersion bath thermoplastic polymer sealed control room vacuum protocol manufacture process. Motor frame protected by synthetic woven textile fiber, silica fiber high heat-resistant insulator shielding, preform slurry non ionic silicate carbon nanofoam CNFs dispersion high wear-heat compression resistant light weight insulator, and/or or high tensile strength super alloy woven textile shielding. One by one each battery cell crucible casted or submersion bath thermoplastic polymer sealed control room vacuum protocol manufacture process. All four conductive or non conductive heat-wear high tensile strength and compression resistant insulators are designed and built in monocomb and corrugated compartmented composite combinations thermoplastic sealed, layered or woven shielded. Number 16. Motor crucible casted or 1.0 to 2.5 phase extrusions highly pure metal or super alloy composite coils, composite windings, and alumina, copper, wire annealing, drawing, and spun coils or other highly pure metal including highly pure metal or super alloy drawing and annealing process for wire. Motor composite coils, composite windings usually copper or super alloy includes continuous or numeric interval spools shapes of rod, cylinder, sphere, rectangle, or square crucible casted or 1.0 to 2.5 phase extrusions. Motor electronic components brushes carbon nanofoam CNFs with or without ionic suspension elements each brush alternate carbon nanofoam inductors, and antinode coupler continuous or numeric ramps positive and negative terminal measured in Volts and monitors positive and negative terminal measured in Volts and negative and negative terminals measure in 0 hms of inductor, antinode coupler, and ground series and parallel circuits. Spun numeric wrapped super alloy copper wire are thermoplastic polymer dipped or protected synthetic woven fibers, silica woven fibers, or high tensile strength super alloy carbon nanofoam CNFs shielding. Motor frame protected by synthetic woven textile fiber, silica fiber high heat-resistant insulator shielding, preform slurry non ionic silicate carbon nanofoam CNFs dispersion high wear-heat compression resistant light weight insulator, and/or or high tensile strength super alloy woven textile shielding. One by one all composite or wire motor coils and windings are crucible casted or submersion bath thermoplastic polymer sealed control room vacuum protocol manufacture process. Three heat-wear high tensile strength and Variable hydraulic preform slurry non ionic silicate carbon nanofoam CNFs dispersion high wear-heat compression resistant light weight insulators are designed and built in monocomb and corrugated compartmented composite combinations thermoplastic sealed, layered or woven shielded. Crucible casted or 1.0 to 2.5 phase extrusions motor rods, bearings, casings, housings, and assemblies are manufactured and assembled. Number 17. Alternate carbon nanofoam inductor ACNFI electronic storage media is manufactured plates, sheets, foil, or leaf on ceramic, highly pure metal, super alloy, or distillation reservoir alternate carbon nanofoam inductor ACNFI annealing, drawing, and spun pressed electronic tape 3250 bits per second BPS, 6250 bits per second BPS, 7 MM millimeter, and compact disc CD writable random access memory WRAM.

3. Visible light enters the lightweight universal spectra camera and monitor panel shell optical glass lens of added and subtracted magnification lenses travelling to scientific mirror reflecting visible light onto analogous photo electron active chemical film and lightweight universal spectra camera and monitor panel shell photo reflector and receptor precision silica alumina glass or thermoplastic polymer beads. The precision silica alumina glass or thermoplastic polymer beads occupy vertical and horizontal panel shell segments of the universal spectra camera and monitor panel shell receiving visible light. Numbered sums of reflected delineations from precision silica alumina glass or thermoplastic polymer beads emitters of visible light spectra waveform frequency onto thermoplastic polymer sealed fiber optic cables process in nanoseconds spectra waveform frequency to central processing unit CPU waveform generator frequency counters and analyzers of waveform frequency added and subtracted changes of the order of wavenumber data output in nanoseconds spectra waveform frequency pure light, filtered light, colored light, and reflective light electronic storage medium random access memory RAM and writable random access memory WRAM compact disc. Numbered sums of reflected centers from precision silica alumina glass or thermoplastic polymer beads emitters of visible light spectra waveform frequency onto thermoplastic polymer sealed fiber optic cables process in nanoseconds spectra waveform frequency to central processing unit CPU waveform generator frequency counters and analyzers of waveform frequency added and subtracted changes of the order of wavenumber data output in nanoseconds spectra waveform frequency pure light, filtered light, colored light, and reflective light electronic storage medium random access memory RAM and writable random access memory WRAM compact disc. The central processing unit CPU waveform generator spectra monitor random access memory RAM data input is received by central processing unit CPU waveform generator processor of spectra waveform frequency added and subtracted changes of the order of wavenumber data output in nanoseconds spectra waveform frequency numbered emitters of pure light, filtered light, colored light, and reflective light onto fiber optic cables and analogous precision silica alumina glass or thermoplastic polymer beads emitters of pure light, filtered light, colored light, and reflective light numbered segments of the monitor panel shell equal to the vertical and horizontal picture resolution. The universal spectra monitor panel shell precision silica alumina glass or thermoplastic polymer beads numbered segments of the polarized optical silica alumina glass panel or thermoplastic polymer shell is finished with touch screen kiosk vertical and horizontal annealing, drawing, and spun pressed strips of highly pure metal alumina and alternate carbon nanofoam inductor ACNFI negative electron molecules touch screen kiosk sensory cells printed conductive series and parallel circuits shielded cables process in nanoseconds negative electron molecules waveform frequency to central processing unit CPU waveform generator added and subtracted changes of the order of wavenumber data output in nanoseconds negative electron molecules waveform frequency. The pure light, filtered light, colored light, and reflective light data output spectra waveform frequency is received by central processing unit CPU waveform generator printer of pure light, filtered light, colored light, and reflective light scale ink composite printed film.
